(19) United States
(12) Patent Application Publication
(10) Pub. No.: US 2018/0210077 A1
(43) Pub. Date: Jul. 26, 2018

(54) SYSTEM AND METHOD FOR LOCATING FIXTURES USING RF ANTENNAS

(71) Applicant: Wal-Mart Stores, Inc., Bentonville, AR (US)

(72) Inventors: Nicholaus Adam Jones, Fayetteville, AR (US); Aaron Vasgaard, Fayetteville, AR (US); Matthew Allen Jones, Bentonville, AR (US)

(21) Appl. No.: 15/880,733

(22) Filed: Jan. 26, 2018

Related U.S. Application Data
(60) Provisional application No. 62/450,856, filed on Jan. 26, 2017.

(51) Int. Cl. G01S 13/86; G01S 13/42; G01S 7/41

(52) U.S. Cl. CPC G01S 13/86; G01S 13/89; G01S 7/41; G01S 13/42

(57) ABSTRACT

Systems and methods are taught herein to determine a location and a dimension of a fixture using an RFID reader. The RFID reader can include an RF antenna array including one or more RF antennas. By measuring reflected RF signals from the fixture and properties of the reflected signals, location and dimension of the fixture are estimated.

### BACKGROUND

It can be difficult to locate fixtures or shelving units with respect to a planogram in a large facility.

### DESCRIPTION OF DRAWINGS

Illustrative embodiments are shown by way of example in the accompanying drawings and should not be considered as a limitation of the present disclosure:

FIG. 1 illustrates a system for determining location or dimension of a fixture using an RFID reader according to embodiments of the present disclosure;

FIG. 2 illustrates a side view of the system of FIG. 1 in accordance with embodiments of the present disclosure;

FIG. 3 illustrates an exemplary computing device in accordance with embodiments of the present disclosure;

FIG. 4 illustrates an exemplary embodiment of an RFID reader including an RF antenna array in accordance with embodiments of the present disclosure; and

FIG. 5 illustrates a flowchart of a process for determining a location and a dimension of a fixture using an RFID reader according to embodiments of the present disclosure.

FIG. 6 illustrates a flowchart of a process for autonomously adjusting the position of a fixture using an RFID reader according to embodiments of the present disclosure.

FIG. 7 illustrates a flowchart of a process for autonomously placing items on a fixture using an RFID reader according to embodiments of the present disclosure.

### DETAILED DESCRIPTION

Described in detail herein are methods and systems for measuring the location and/or dimensions of fixtures in a facility using RFID readers. For example, location and measurement systems and methods can be implemented using an RFID reader including an RF antenna array comprising one or more RF antennas and a computing device operatively coupled to the RF antenna array.

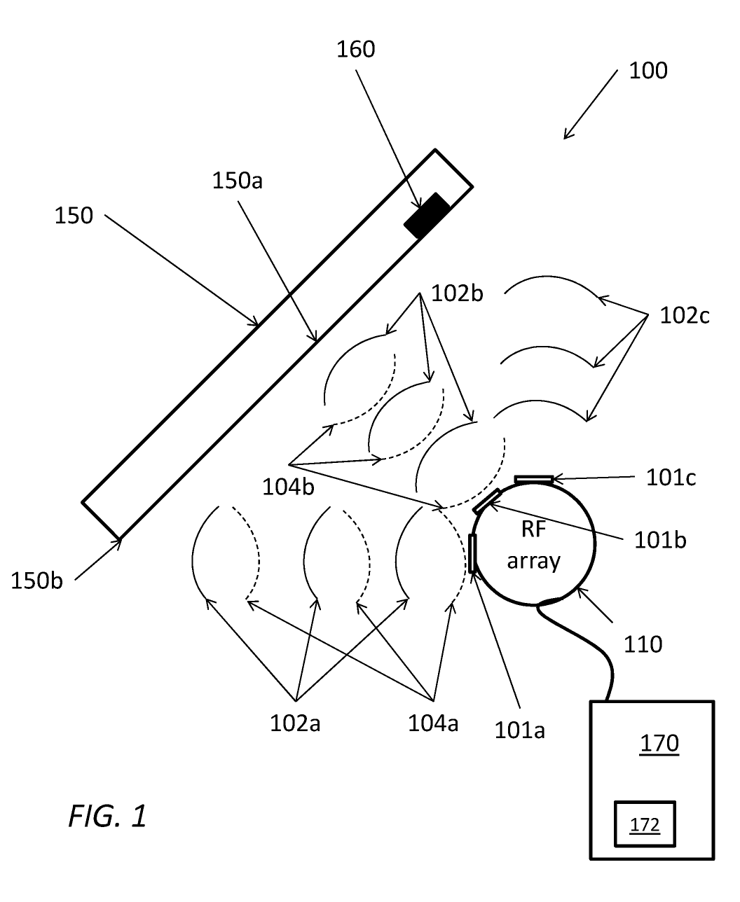

FIG. 1 illustrates a system for determining location and/or dimensions of a fixture using an RFID reader according to embodiments of the present disclosure. The system 100 can include an RFID reader 110 and a computing device 170. The RFID reader 110 can generate transmission signals 102a, 102b, 102c and receive reflected signals 104a, 104b to determine a location and/or dimensions of a fixture 150. In accordance with various embodiments, the system 100 can include an indicator 172 to alert a user.

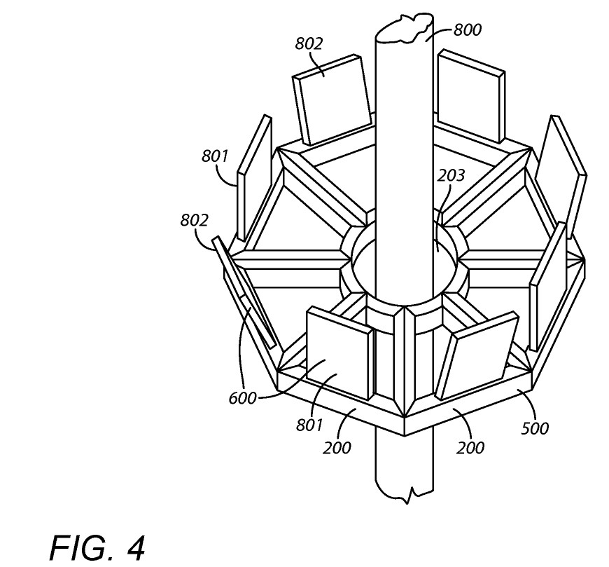

The RFID reader 110 can include an RF antenna array comprising one or more RF antennas 101a, 101b, 101c. As shown in FIG. 1, the RFID reader 110 has three RF antennas 101a, 101b, 101c. Additional antennas can be added to the RF antenna array to improve the resolution of the system 100 (e.g., five, ten, fifteen, twenty antennas can be utilized). One of ordinary skill in the art will appreciate that any number of RF antennas may be used in accordance with embodiments of the present disclosure. An exemplary embodiment of an RFID reader 110 is described below in more detail with reference to FIG. 4.

In some embodiments, the RF transmission signals can be carrier signals having specified frequencies. As shown in FIG. 1, a first subset of the RF transmission signals 102a, 102b are intercepted by the fixture 150 and are reflected back towards the RFID reader 110. The reflected signals 104a, 104b can be received by one or more of the RF antennas 101a, 101b, 101c. A second subset of RF transmission signals 102c is not intercepted by the fixture and thus do not have a corresponding RF reflected signal.

The computing device 170 can execute a mapping engine 172 to use the one or more RF antennas 101a, 101b, 101c to determine information about the reflected RF signals 104a, 104b. For example, the computing device 170 can execute the mapping engine 172 to use the one or more RF antennas 101a, 101b, 101c to receive RF reflected signals 104a, 104b reflected from the fixture 150 where the RF reflected signals 104a, 104b correspond to the first subset of RF transmission signals 102a, 102b. In certain embodiments, the computer device 170 can determine the second subset of RF transmission signals 102c that do not have a corresponding RF reflected signal and from which of the one or more RF antennas 101c the second subset of RF transmission signals radiated. The computing device 170 can execute the mapping engine 172 to estimate a dimension (such as length, width, or height) of the fixture 150 based on the first and second subsets of RF transmission signals and the one or more antennas from which the first and second subsets of RF transmission signals radiated (e.g., a position and/or angle of the one or more antennas relative to the fixture 150 and/or relative to each other).

In some embodiments, the computing device 170 can execute the mapping engine 172 to control the RFID reader 110 to transmit the RF transmission signals sequentially such that an RF transmission signal is transmitted from first one of the antennas, then from a second one of the antennas, then from a third one of the antennas, and so on. The computing device can control the RFID reader 110 to wait a specified time period for an RF reflected signal between transmissions. Using this sequential approach, the computing device 170 can associate RF reflected signals with their respective RF transmission signals and can determine which RF transmission signals do not result in RF reflected signals.

In some embodiments, the computing device 170 can execute the mapping engine 172 to control the RFID reader 110 to transmit the RF transmission signals from two or more antenna simultaneously or nearly simultaneously where the RFID reader 110 can be configured to use a different frequency for each antenna. Using this approach, the computing device 170 can associate RF reflected signals with their respective RF transmission signals based on the frequencies and can determine which RF transmission signals do not result in RF reflected signals. In some embodiments, the RF transmission signals can include an amplitude or frequency modulation that will facilitate identification and correlation of associated RF reflected signals.

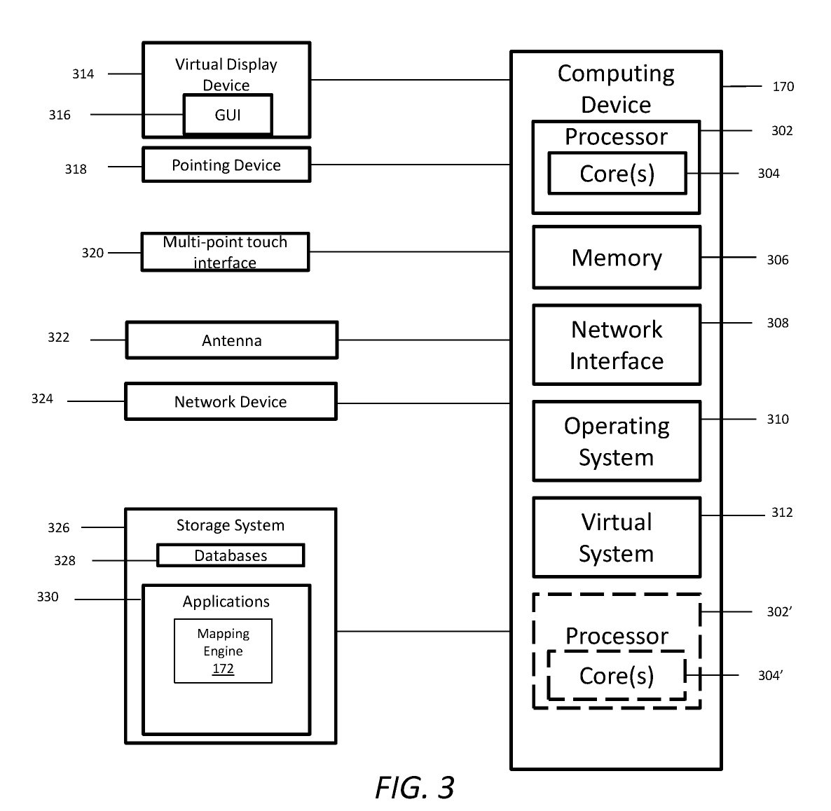

In some embodiments, the computing device 170 can use the one or more RF antennas 101a, 101b, 101c to measure a property of the RF reflected signals 104a, 104b. In some embodiments, the measured property of the RF reflected signals can be one or more of time of flight, arrival angle, RF frequency, received signal strength indicator, or any other suitable property. For example, the transmitted RF signals 102b are intercepted and reflected by the fixture 150 at a midpoint 150a of the fixture 150. Similarly, the transmitted signals 102a are intercepted and reflected by the fixture 150 at an endpoint 150b of the fixture 150. Because the distance from the RFID reader 110 to the midpoint 150a is less than the distance from the RFID reader 110 to the endpoint 150b, the time of flight for the reflected signals 104a to return to the one or more RF antennas 101a, 101b, 101c will be greater than for reflected signals 104b. Similarly the RF reflected signal from the end point 150 may be more attenuated then the RF reflected signal from the midpoint due to, for example, scattering of the RF transmission. Using the measured properties of the reflected RF signals 104a, 104b, the computing device 170 can estimate the location of the fixture relative to the one or more RF antennas and/or can estimate the dimensions of the fixture. An exemplary computing device 170 for use in embodiments of the present disclosure is described in greater detail below with reference to FIG. 3.

The computing device 170 can compare the estimated location of the fixture 150 to a planned position of the fixture in a planogram. In some embodiments, the computing device 170 can alert the user using the indicator 172 if the estimated location of the fixture 150 differs from the planned position of the fixture 150.

The RFID reader 110 can emit RF transmission signals 102a, 102b, 102c through any angle up to and including 360°. In some embodiments, the RFID reader 110 can generate RF transmission signals 102a, 102b, 102c over a full 4π solid angle or only a portion thereof. In some embodiments, the transmission signals 102a, 102b, 102c may be preferentially directed downward from an RFID reader 110 that is suspended from a ceiling of a store.

In some embodiments, the one or more RF antennas in the RFID reader 110 can be phased-array antennas. In some embodiments, phased-array antennas can provide greater spatial discrimination and resolution than non-phased array antennas.

In some embodiments, one or more RFID tags 160 can be proximate to or attached to the fixture 150. When estimating the location or dimension of the fixture 150 using the transmitted RF signals (for example, carrier wave signals), the RF antennas can intentionally detune the frequency, amplitude, modulation, or other characteristics of the transmission signals to avoid interrogating the RFID tags. In such an embodiment, the reflected RF signals from the fixture 150 are indicative of the presence of a bulk object rather than an RFID tag. However, there is a possibility that at least a portion of the reflected RF signals could create a null zone through multipathing that would prevent receiving the portion of the reflected RF signals. In such embodiments, detection of the location of proximate RFID tags can provide corroborative evidence of the loss of reflected RF signals. In some embodiments, the computing device 170 can use the one or more RF antennas 101a, 101b, 101c to generate second RF transmission signals to interrogate the one or more RFID tags 160. The computing device 170 can then receive the RF emitted signals from the one or more RFID tags via the one or more RF antennas 101a, 101b, 101c and measure a property of the RF emitted signals. The computing device 170 can estimate the locations of the one or more RFID tags using the measured property. In some embodiments, the computing device 170 can compare the estimated locations of the one or more RFID tags 160 to the estimated location of the fixture 150 to mitigate null zones due to multipathing.

It can be important to distinguish RFID tags 160 that are affixed or attached in some way relative to the fixture 150 from RFID tags that are temporarily traversing past the fixture 150 (for example, an RFID tag attached to a product in a customer's shopping cart). In some embodiments, the computing device 170 can interrogate the RFID tag(s) for a length of time sufficient to determine that the RFID tag is stationary with respect to the fixture 150. In some embodiments, the computing device 170 can configure the RF transmitted signals to send only a carrier wave to which RFID tags will not respond. In some embodiments, the computing device 170 can employ a pre-selection process (specified, for example, in the EPC Gen2 air interface protocol) to select only a subset of the RFID tags 160 (which may include none of the tags) to respond.

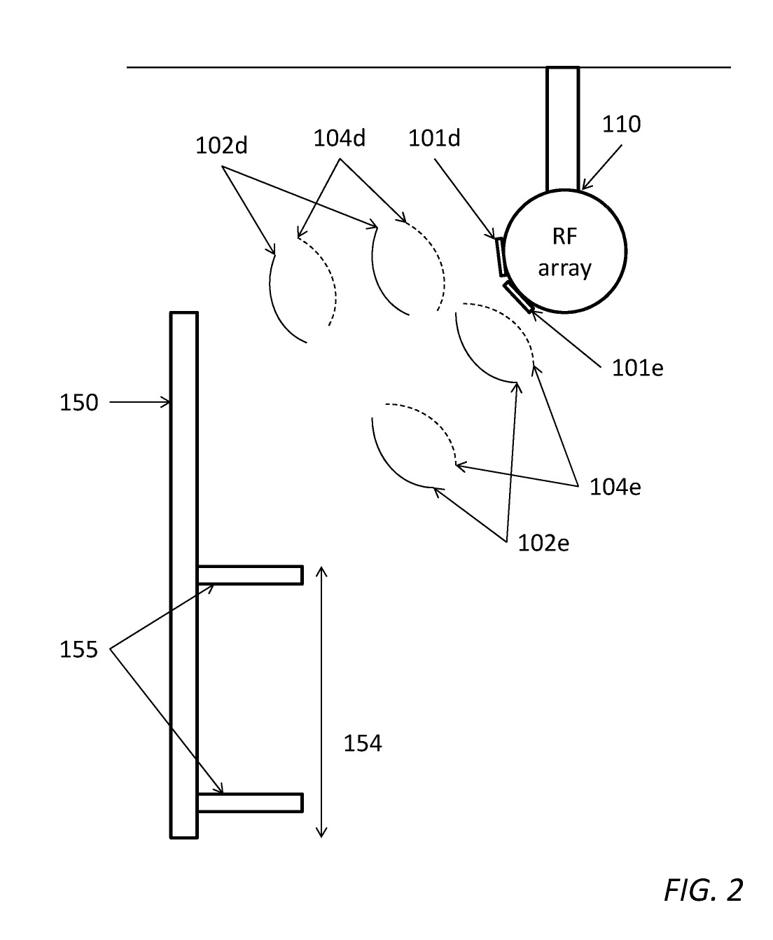

FIG. 2 illustrates a side view of the system 100 illustrated in FIG. 1. As shown, the one or more RF antennas 101d, 101e can generate RF transmission signals 102d, 102e at different elevation angles with respect to the RFID reader 110. By measuring properties of RF reflected signals 104d, 104e received by RF antennas 101d, 101e oriented at different elevation angles, the systems and methods described herein can determine the dimension (e.g., height 154) or location of the fixture 150 or a component 155 of the fixture 150 such as a shelf. In some embodiments, the computing device 170 can estimate the location or dimension of the fixture 150 or component 155 of the fixture 150 using measured properties of the reflected RF signals 104d, 104e received by the one or more RF antennas 101d, 101e and the differences in elevation angle among the one or more RF antennas 101d, 101e.

In some embodiments, the location or dimension of the component 155 can be estimated continuously as the location or dimension is changing. In some embodiments, the computing device 170 can compare the estimated location or dimension of the component 155 of the fixture 150 with a planned location of the component 155 in a planogram. In various embodiments, the computing device 170 can alert a user using the indicator 172 if the estimated location of the component 155 of the fixture 150 differs from the planned location.

In some embodiments, the fixture 150 can include a modular shelving unit or a shelf in the modular shelving unit.

FIG. 3 is a block diagram of an example computing device 170 for implementing exemplary embodiments of the present disclosure. Embodiments of the computing device 170 can implement embodiments of the mapping engine 172. The computing device 170 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 170 may store computer-readable and computer-executable instructions or software (e.g., applications 330 such as the mapping engine 172) for implementing exemplary operations of the computing device 170. The computing device 170 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (304 and 304′) processor. Either or both of processor 302 and processor(s) 302′ may be configured to execute one or more of the instructions described in connection with computing device 170.

Visualization may be employed in the computing device 170 so that infrastructure and resources in the computing device 170 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

A user may interact with the computing device 170 through a visual display device 314, such as a computer monitor, which may display one or more graphical user interfaces 316, multi touch interface 320 and a pointing device 318.

The computing device 170 may also include one or more storage devices 326, such as a hard-drive, CD-ROM, or other computer readable media, for storing data and computer-readable instructions and/or software that implement exemplary embodiments of the present disclosure (e.g., applications). For example, exemplary storage device 326 can include one or more databases 328 for storing information regarding the sounds produced by actions taking place in a facility, sound signatures, and sound patterns. The databases 328 may be updated manually or automatically at any suitable time to add, delete, and/or update one or more data items in the databases.

The computing device 170 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 170 and a network and/or between the computing device 170 and other computing devices. The network interface 308 may include a built-in network adapter, network interface card, PCMCIA network card, card bus network adapter, wireless network adapter, USB network adapter, modem or any other device suitable for interfacing the computing device 170 to any type of network capable of communication and performing the operations described herein.

The computing device 170 may run any operating system 310, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 170 and performing the operations described herein. In exemplary embodiments, the operating system 310 may be run in native mode or emulated mode. In an exemplary embodiment, the operating system 310 may be run on one or more cloud machine instances.

FIG. 4 illustrates an exemplary embodiment of an RFID reader including an RF antenna array 500 in accordance with the present disclosure. In this embodiment, the octagon-shaped RF antenna array includes eight frame components 200 that each has a single corresponding RF antenna 600. These RF antennas 600 are positioned to radiate RF transmission signals outwardly from the array. In some embodiments, at least two RF antennas 600 are disposed on substantially opposing sides of the 360 degree RF antenna array 500 and hence are configured to radiate RF transmission signals outwardly therefrom.

In some embodiments, each of the RF antennas 600 can share a common mounting pitch. In other embodiments as shown in FIG. 4, some of the RF antennas 600 can be pitched differently from one another to radiate RF transmission signals at different elevation angles. As shown in FIG. 4, a first group 801 of four of the RF antennas 600 radiate at a first substantially-identical elevation angle while a second group 802 of the remaining four RF antennas 600 radiate at a different substantially-identical elevation angle. (This reference to “substantially-identical” will be understood to refer to some appropriate small range of differences, such as plus-or-minus five degrees, plus-or-minus three degrees, plus-or-minus one degree, or the like.)

In some embodiments, the elevation angle at which the RF antennas radiate can be selected based on the height and spacing of the units so as to provide a uniform distribution of radio frequency power throughout the targeted space. If desired, the distribution of power can account for overlapping power from adjacent readers. For example: the elevation angle of an RF antenna pointing down a line between adjacent RF antennas might be tilted down more than the adjacent RF antennas in order intercept a fixture located more directly below the unit.

In this particular illustrative example, the RF antennas 600 of the first group 801 are interleaved with the RF antennas 600 of the second group 802. In some embodiments, it may be useful to have four adjacent RF antennas 600 share a same elevation angle while the remaining four RF antennas 600 have a different elevation angle. In other settings, it might be useful to individually adjust each RF antenna 600 such that each has a different elevation angle. In some embodiments, the RF antennas are mounted at substantially the same vertical position on the RFID reader. In other embodiments, one or more of the RF antennas can be mounted vertically below other RF antennas.

In some embodiments, the plurality of RF antennas 600 can be disposed higher than an expected location of at least 90% of the fixtures to be interrogated. Such a height can and will vary from one facility to the next. In some cases, a height of 8 feet or 10 feet may be appropriate while in other cases it may be desired to observe a height of, say, 12 to 15 feet. The present disclosure also contemplates selecting a height that is greater than, or less than, the above mentioned 90% requirement. In some eases, for example, the RF antennas may only be higher than an expected location of, say, 50% or 75% of the fixtures to be interrogated while in other cases it may be appropriate for the antenna units to be placed higher than the expected location of all fixtures within the facility.

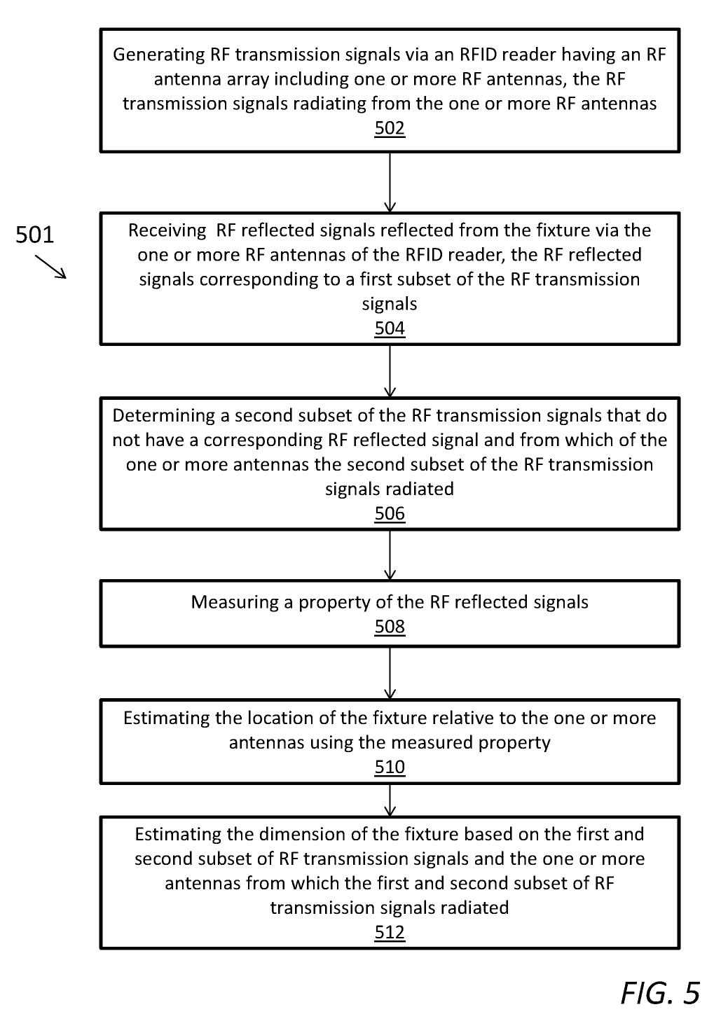

FIG. 5 illustrates a flowchart illustrating a process 501 of determining a location and a dimension of a fixture using an RFID reader according to embodiments of the present disclosure. The method 501 includes generating RF transmission signals via an RFID reader having an RF antenna array including one or more RF antennas (step 502). Generation of the RF transmission signals can be controlled by, e.g., the computing device 170 executing the mapping engine 174. The RF transmission signals radiate from the one or more RF antennas. Generating the RF transmission signals via the RFID reader can be performed, for example but not limited to, using one or more RF antennas to generate RF transmission signals as described above with relation to FIGS. 1, 2, and 4. The method includes receiving RF reflected signals reflected from the fixture via the one or more RF antennas of the RFID reader (step 504). The RF reflected signals correspond to a first subset of the RF transmission signals. For example, the RF transmission signals and the RF reflected signals can be similar to those described above with reference to FIGS. 1 and 2. In some embodiments, the computing device 170 can be used to receive the RF reflected signals using the one or more RF antennas as described above with reference to FIG. 1.

The method includes determining a second subset of the RF transmission signals that do not have a corresponding RF reflected signal and from which of the one or more antennas the second subset of the RF transmission signals radiated (step 506). The determination of the second subset of RF transmission signals and the one or more antennas from which they radiated can be performed, for example, using a computing device 170 as described above with reference to FIG. 1. The method includes measuring a property of the RF reflected signals (step 508). In accordance with various embodiments, the measured property can include, for example, time of flight, arrival angle, frequency, or received signal strength indicator.

The method includes estimating the location of the fixture relative to the one or more antennas using the measured property (step 510). For example, the estimation of location can be done using a computing device 170 to determine the time of flight of the RF reflected signals 104a, 104b as described above with reference to FIG. 1. The method includes estimating the dimension of the fixture based on the first and second subset of RF transmission signals and the one or more antennas from which the first and second subset of RF transmission signals radiated (step 512). For example, the estimation of dimension can be performed by a computing device 170 based on the first subset of transmission signals 102a, 102b and the antennas 101a, 101b from which they radiated and the second subset of transmission signals 102c and the antennas 101c from which they radiated as described above with reference to FIGS. 1 and 2.

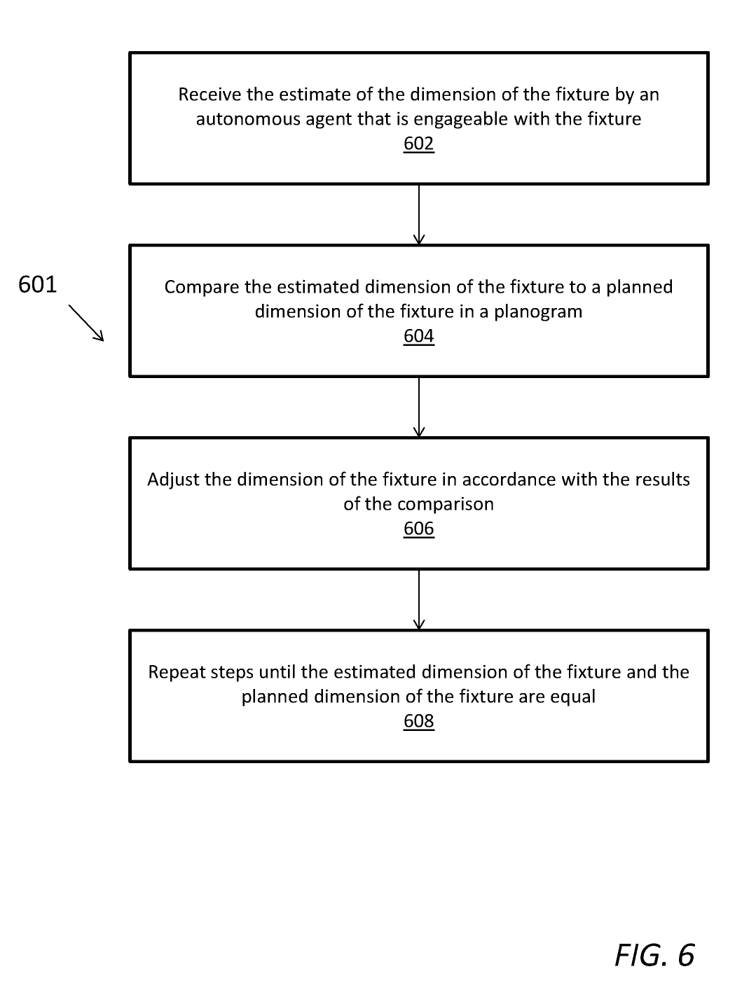

FIG. 6 illustrates a flowchart of a process 601 for autonomously adjusting the position of a fixture using an RFID reader according to embodiments of the present disclosure. In some embodiments, systems and methods described herein can provide estimates of dimensions or locations of the fixture to autonomous agents that can utilize the information to shift or otherwise re-position at least a portion of the fixture to adjust the dimension or location. For example, an autonomous robot or lifter can use estimates of fixture location or shelf height provided by systems and methods described herein to arrange or re-arrange portions of a facility to conform to a planogram without human intervention.

The method 601 includes receiving the estimate of the dimension of the fixture by an autonomous agent that is engageable with the fixture (step 602). In some embodiments, the dimension of the fixture can be estimated by employing the method 501 or system 100 described above. In some embodiments, the autonomous agent can be a self-powered and self-navigable agent such as an autonomous robot or lifter. The autonomous agent can engage with the fixture in various embodiments through application of physical force such as by grasping, pushing, or lifting the fixture or portion of the fixture. The method includes comparing the estimated dimension of the fixture to a planned position of the fixture in a planogram (step 604). For example, the estimate dimension can be translational or rotational position of a shelving unit or height or length of a shelf in some embodiments. The measured and estimated dimension can be compared to the desired position as described in a planogram to determine the difference or error between the measured and planned dimension.

The method includes adjusting the dimension of the fixture in accordance with the results of the comparison (step 606). For example, the autonomous agent can adjust the dimension (e.g., location) of a shelving unit in a direction that is expected to reduce the difference or error in dimension as compared to the planned dimension. The method includes repeating the steps until the estimated dimension of the fixture and the planned dimension of the fixture are equal (step 608). For example, the autonomous agent can continue to receive dimensional estimates and to adjust the dimension until it conforms to the value prescribed by the planogram.

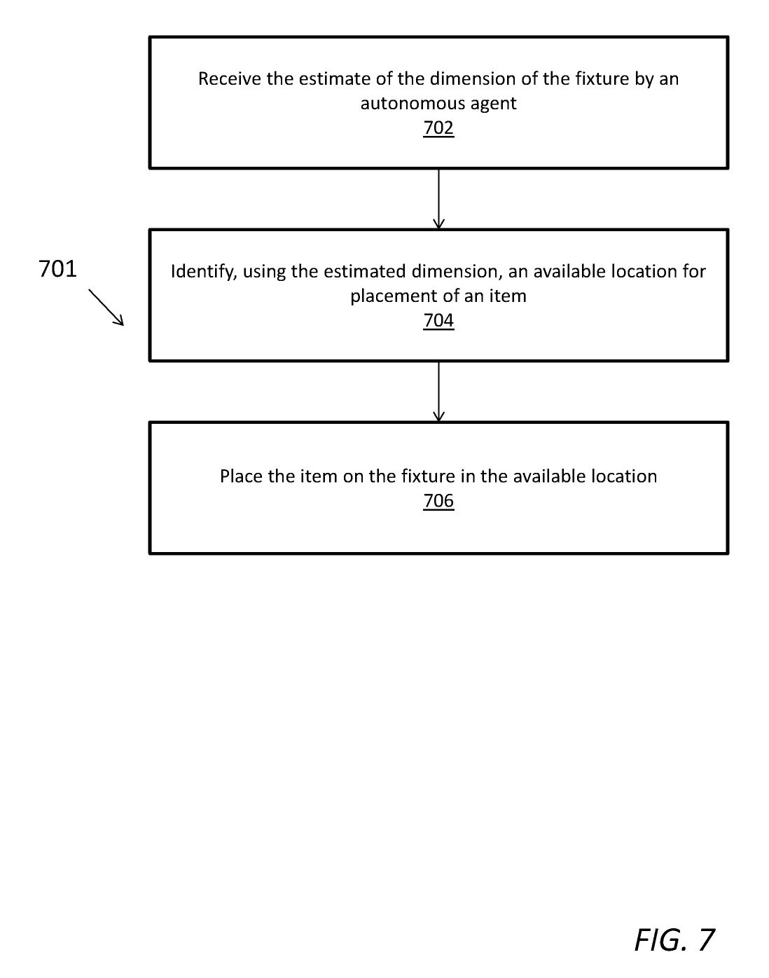

FIG. 7 illustrates a flowchart of a process 701 for autonomously placing items on a fixture using an RFID reader according to embodiments of the present disclosure. In some embodiments, systems and methods described herein can be used to identify available locations on a fixture and autonomously place items in the available locations without human intervention. The method 701 includes receiving the estimate of the dimension of the fixture by an autonomous agent (step 702). In some embodiments, the dimension of the fixture can be estimated by employing the method 501 or system 100 described above. For example, the system 100 can be used to measure expected or predicted heights of items on a shelf to identify the presence or absence of an item at different locations along the shelf. The method includes identifying, using the estimated dimension, an available location for placement of an item (step 704). For example, systems and methods described herein can compare expected locations of items (e.g., as determined by whether an object having certain dimensions is identified at the location) with predicted locations found on a planogram. In locations where there is a discrepancy (i.e., an item is not found where predicted or prescribed by the planogram), the location can be identified as an available location. The method includes placing the item on the fixture in the available location (step 706). For example, the autonomous agent can lift or push the item and place it at the available location.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component, or step. Likewise, a single element, component, or step may be replaced with a plurality of elements, components, or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions, and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A system to determine a location and a dimension of a fixture using an RFID reader, comprising:
an RFID reader including an RF antenna array comprising one or more RF antennas;
a computing system operatively coupled to the RFID reader, the computing system including a processor that can execute instructions to:
generate RF transmission signals via the RFID reader, the RF transmission signals radiating from the one or more RF antennas;
receive RF reflected signals reflected from the fixture via the one or more RF antennas of the RFID reader, the RF reflected signals corresponding to a first subset of the RF transmission signals;
determine a second subset of the RF transmission signals that do not have a corresponding RF reflected signal and from which of the one or more antennas the second subset of the RF transmission signals radiated;
measure a property of the RF reflected signal;
estimate the location of the fixture relative to the one or more antennas using the measured property; and
estimate the dimension of the fixture based on the first and second subset of RF transmission signals and the one or more antennas from which the first and second subset of RF transmission signals radiated.

2. The system of claim 1, wherein the measured property of the RF reflected signals is one or more of time of flight, arrival angle, frequency, or received signal strength indicator.

3. The system of claim 1, wherein the fixture includes a modular shelving unit or a shelf in the modular shelving unit.

4. The system of claim 3, wherein the processor further executes instructions to compare the estimated location of the fixture to a planned position of the fixture in a planogram.

5. The system of claim 4, further comprising an indicator and wherein the processor can further execute instructions to alert a user using the indicator if the estimated location differs from the planned position.

6. The system of claim 1, wherein the one or more RF antennas are phased-array antennas.

7. The system of claim 1, wherein the RF transmission signals do not interrogate RFID tags because of a frequency, amplitude, or modulation of the RF transmission signals.

8. The system of claim 1, wherein the processor further executes instructions to:
interrogate one or more RFID tags proximate to the fixture by generating second RF transmission signals using the one or more RF antennas;
receive RF emitted signals from the one or more RFID tags via the one or more RF antennas;
measure a property of the RF emitted signals; and
estimate the locations of the one or more RFID tags relative to the one or more antennas using the measured property.

9. The system of claim 8, wherein the processor further executes instructions to compare estimated locations of the one or more RFID tags to the estimated location of the fixture to mitigate null zones due to multipathing.

10. The system of claim 1, wherein the one or more antennas are arranged in the RF antenna array over 360 degrees.

11. The system of claim 1, wherein the RF antenna array is capable of suspension from a ceiling of the store.

12. A method of determining a location and a dimension of a fixture using an RFID reader, the method comprising:
generating RF transmission signals via an RFID reader having an RF antenna array including one or more RF antennas, the RF transmission signals radiating from the one or more RF antennas:
receiving RF reflected signals reflected from the fixture via the one or more RF antennas of the RFID reader, the RF reflected signals corresponding to a first subset of the RF transmission signals;
determining a second subset of the RF transmission signals that do not have a corresponding RF reflected signal and from which of the one or more antennas the second subset of the RF transmission signals radiated;
measuring a property of the RF reflected signals;
estimating the location of the fixture relative to the one or more antennas using the measured property; and
estimating the dimension of the fixture based on the first and second subset of RF transmission signals and the one or more antennas from which the first and second subset of RF transmission signals radiated.

13. The method of claim 12, wherein the measured property of the RF reflected signals is one or more of time of flight, arrival angle, frequency, or received signal strength indicator.

14. The method of claim 12, wherein the fixture includes a modular shelving unit or a shelf in the modular shelving unit.

15. The method of claim 14, further comprising comparing the estimated location of the fixture to a planned position of the fixture in a planogram.

16. The method of claim 15, further comprising alerting a user using an indicator if the estimated location differs from the planned position.

17. The method of claim 12, further comprising:
interrogating one or more RFID tags proximate to the fixture by generating a second RF transmission signals using the one or more RF antennas;
receiving RF emitted signals from the one or more RFID tags via the one or more RF antennas;
measuring a property of the RF emitted signals; and
estimating the locations of the one or more RFID tags relative to the one or more antennas using the measured property.

18. The method of claim 17, further comprising comparing estimated locations of the one or more RFID tags to the estimated location of the fixture to mitigate null zones due to multipathing.
